(19) United States
(12) Patent Application Publication
(10) Pub. No.: US 2025/0392621 A1
(43) Pub. Date: Dec. 25, 2025

(54) SYSTEMS AND METHODS FOR MULTI-CONTEXT DATA LOSS PREVENTION

(71) Applicant: DOCONTROL, INC., New York, NY (US)

(72) Inventor: Adam Gavish, New York, NY (US)

(21) Appl. No.: 18/642,392

(22) Filed: Apr. 22, 2024

(51) Int. Cl. H04L 9/40

(52) U.S. Cl. CPC H04L 63/20

(57) ABSTRACT

The present disclosure relates to techniques for enforcing multi-context data loss prevention (MCDLP) policies. A security enforcement platform facilitates creation and enforcement of MCDLP security policies that are capable of assessing various contextual parameters relating to activity events that involve sharing, transmitting, or providing access to data assets that include sensitive or protected information. In some embodiments, the security enforcement platform can be configured to remotely monitor activity events originating across various SaaS platforms and to remotely enforce the MCDLP security policies on data assets stored the SaaS platforms. In response to detecting a violation of one or more MCDLP security policies, the security enforcement platform can execute various remediation functions associated with preventing or revoking access to data assets containing sensitive or protected information.

### TECHNICAL FIELD

This disclosure is related to improved techniques and technologies for data loss prevention (DLP). In certain embodiments, improved data loss prevention techniques can more comprehensively assess security risks, such as those associated with the unauthorized sharing or transmission of sensitive data, by analyzing multiple contexts relating to data sharing or data transmission events. The multi-context data loss prevention (MCDLP) techniques described herein may be implemented to protect data stored on SaaS systems, enterprise systems, and/or other systems.

### BACKGROUND

Generally, DLP technologies are designed to prevent unauthorized access, transfer, and/or disclosure of sensitive information. In many cases, DLP technologies focus on identifying, monitoring, and controlling the flow of sensitive information within an organization's network, as well the flow of information that exits the organization's network. In some examples, DLP policies can be designed to protect PII (personal identifiable information), PHI (personal health information), IP (intellectual property), credit card information, password information, confidential business documents, and/or other types of sensitive information.

Traditional techniques for implementing DLP policies on an organization's data are narrowly focused and, in most cases, only involve scanning e-mails or files to detect whether sensitive information is present and, if detected, preventing the transmission of the e-mails or files containing the sensitive information in some scenarios. Notably, however, traditional techniques fail to consider other contextual information that may be useful for assessing whether the sharing or transmission of the organization's data is authorized or violates the organization's security policies. Additionally, traditional DLP techniques lack functionality for verifying or confirming whether or not a data sharing or transmission event is authorized.

In recent years, there has been widespread adoption of third-party software-as-a-service (Saas) platforms by organizations, driven by their convenience, scalability, and cost-effectiveness. These SaaS platforms may be utilized by an organization's users to streamline a variety of organizational operations. In some examples, the SaaS platforms can offer software solutions for email services, collaboration platforms, content management services, cloud storage platforms, human resource management systems, financial management systems, and many other solutions. Typically, the users of the organization may establish accounts with multiple SaaS platforms that provide solutions related to the users role at the organization. However, an organization may have many users, and each user may utilize multiple SaaS platforms.

While SaaS platforms greatly expand the capabilities of an organization and provide access to a wide variety of ready-to-use software solutions, the decentralization of an organization's data across the SaaS platforms poses serious data security concerns and introduces technical complexities with respect to enforcing DLP protections on the organization's data. Decentralization, which is typically a benefit of SaaS platforms, becomes a drawback of SaaS systems when it comes to enforcement of a particular organization's DLP policies. Because SaaS platforms typically operate outside of an organization's internal network, the organization's ability to enforce DLP protections on data stored or shared using the SaaS platforms is extremely limited.

In many cases, a SaaS platform may not provide any functionalities that enable DLP protections to be implemented and, therefore, an organization may be forced to abandon or forego usage of those SaaS platforms, which results in the organization losing access to the software solutions provided by those platforms. Even in scenarios where SaaS platforms may provide controls for activating DLP protections, these functionalities are typically implemented on an account-by-account basis. Therefore, security teams or other users of the organization would be required to configure the DLP protections for each account on each SaaS platform. However, this may not possible in scenarios where an organization has many users (e.g., hundreds or thousands of users), and each user may utilize multiple SaaS platforms.

The background description provided herein is for the purpose of generally presenting context of the disclosure. The materials described in this section are not prior art to the claims in this application and are not admitted to be prior art, or suggestions of the prior art, by inclusion in this section.

### BRIEF DESCRIPTION OF THE DRAWINGS

To facilitate further description of the embodiments, the following drawings are provided, in which like references are intended to refer to like or corresponding parts, and in which:

FIG. 1A is a block diagram of an exemplary system in accordance with certain embodiments;

FIG. 1B is a block diagram of another exemplary system in accordance with certain embodiments;

FIG. 2 is a block diagram illustrating exemplary components of a MCDLP system in accordance with certain embodiments;

FIG. 3 is an exemplary process flow for employing MCDLP according to certain embodiments; and

FIG. 4 is an exemplary method 400 for employing MCDLP according to certain embodiments.

### DETAILED DESCRIPTION OF EXEMPLARY EMBODIMENTS

The present disclosure relates to systems, methods, apparatuses, and techniques for data loss prevention (DLP) and, more specifically, for multi-context data loss prevention (MCDLP). As explained throughout this disclosure, a security enforcement platform facilitates creation and enforcement of MCDLP security policies that are capable of assessing various contextual parameters relating to activities that involve sharing, transmitting, or providing access to data assets that include sensitive or protected information (e.g., such as PII, PHI, financial information, etc.). In addition to scanning or analyzing data assets for the presence of protected information, the MCDLP security policies can be defined and customized to consider contextual parameters that evaluate the roles and statuses of end-users involved with activity events related to sharing, transmitting, or providing access to data assets that include sensitive information. Additionally, the MCDLP security policies can be configured to implement verification functionalities that enable certain end-users to verify or authenticate the activity events. By sourcing and making determinations based upon information from multiple sources, MCDLP provides a more comprehensive manner of assessing contexts and risks associated with the sharing, transmitting, or providing access to sensitive information when compared with prior techniques.

Security personnel and/or other users can create and deploy various types of MCDLP security policies. Each MCDLP security policy may be customized to assess certain types of activity events (e.g., various types of share events or data access events), certain types of end-users (e.g., end-users with particular roles in an organization), and statuses of end-users involved with activity events. The security enforcement platform applies and enforces the MCDLP security policies on activity events that relate to sharing, transmitting, or providing access to an organization's data assets.

When an activity event is detected by the security enforcement platform, contextual information can be obtained from multiple sources to determine whether the received activity event violates each of the MCDLP security policies. The sources of contextual information may include various entity systems. In some examples, identity management systems (IMSs) and/or other subsystem may provide access to role data (e.g., identifying a department in an organization or a job title) for one or more users associated with the activity event, and such role data may be used to determine whether the activity event is authorized or applies to one or more of the MCDLP policies. A human resource information system (HRIS) and/or other subsystem also may provide status data (e.g., indicating a current employment statuses) for one or more end-users associated with the activity event, and such status data may be used to determine whether the activity event is authorized. Data assets subject to the activity event may be scanned for sensitive information. The presence of and/or type of sensitive information in the data assets may be used to determine whether the activity event is authorized. Verification requests and responses may also be used to confirm or deny the context, propriety, or legitimacy of the activity events that involve dissemination or access to sensitive information.

While certain portions of this disclosure may describe exemplary applications of MCDLP technologies and electronic security platforms in the context of SaaS platforms and enterprise systems, it should be recognized that these MCDLP technologies may also be applied to any type of software solution, application, program, platform, or network environment. For example, in certain embodiments, the electronic security platform can alternatively, or additionally, be configured to communicate with and enforce control policies on other types of software applications and programs (e.g., applications installed locally on computing devices and/or other web-based software applications).

As evidenced by the disclosure herein, the inventive techniques set forth in this disclosure are rooted in computer technologies that overcome existing problems in known security and networking systems, including problems associated with protecting, securing, and remediating data assets to enforce DLP protections. The technologies described in this disclosure provide a technical solution for overcoming the aforementioned limitations (as well as other limitations) associated with known techniques, such as overcoming compatibility issues between various network systems (e.g., SaaS platforms) and organizational security policies. In some examples, the DLP technologies described in this disclosure may utilize improved networking techniques to integrate SaaS platforms (and/or other types of software solutions) with an electronic security platform, thereby enabling the electronic security platform to dynamically monitor aspects (e.g., permissions, content, and storage hierarchies) of data assets remotely stored on SaaS platforms. This monitoring information, for example, coupled with a multi-context DLP approach, can then be leveraged by the electronic security platform to automate preventive and/or remediation measures on any data assets subject to an organization's security policies. Moreover, these technologies permit the electronic security platform to enforce remediation policies on third-party platforms in a uniform manner, despite the inconsistent nature in which various SaaS platforms manage and facilitate access to the data assets. This technology-based solution marks an improvement over existing capabilities and functionalities related to DLP by enabling enforcement of an organization's DLP policies across platforms that are typically outside of an organization's control using a centralized electronic security platform having access to multi-context information provided by various subsystems within (or outside of) an organization.

The embodiments described in this disclosure can be combined in various ways. Any aspect or feature that is described for one embodiment can be incorporated into any other embodiment mentioned in this disclosure. Moreover, any of the embodiments described herein may be hardware-based, may be software-based, or, preferably, may comprise a mixture of both hardware and software elements. Thus, while the description herein may describe certain embodiments, features, or components as being implemented in software or hardware, it should be recognized that any embodiment, feature and/or component referenced in this disclosure can be implemented in hardware and/or software.

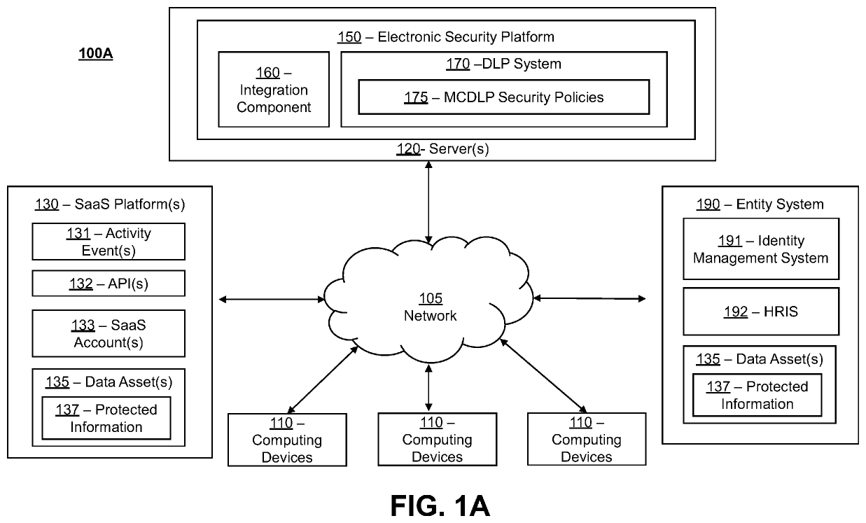

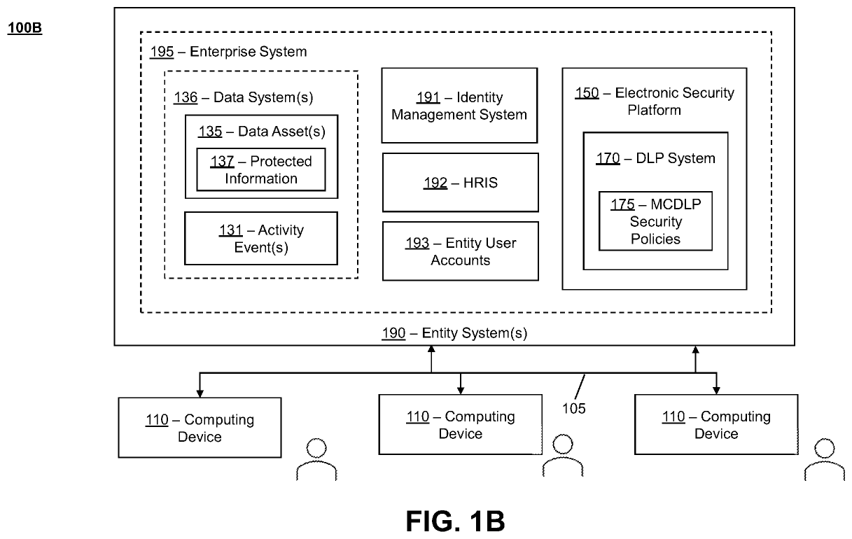

FIG. 1A is a block diagram of an exemplary system 100A in accordance with certain embodiments. In this system 100A, data assets 135 associated with one or more entity systems 190 are stored remotely across one or more SaaS platforms 130, and an electronic security platform 150 remotely enforces security policies (including MCDLP security policies 175) to protect and secure the data assets 135.

In certain embodiments, the system 100A comprises one or more computing devices 110, one or more servers 120, one or more entity systems 190, and one or more SaaS platforms 130 that are in communication over a network 105. An electronic security platform 150 is stored on, and executed by, the one or more servers 120. The network 105 may represent any type of communication network, e.g., such as one that comprises the Internet, a local area network (e.g., a Wi-Fi network), a personal area network (e.g., a Bluetooth network), a wide area network, an intranet, a cellular network, a television network, and/or other types of networks. The system 100A may include any number of computing devices 110, servers 120, SaaS platforms 130, entity systems 190, and/or electronic security platforms 150.

All of the components illustrated in FIG. 1A, including the computing devices 110, servers 120, SaaS platforms 130, entity systems 190, and electronic security platform 150, can be configured to communicate directly with each other and/or over the network 105 via wired or wireless communication links, or a combination of the two. Each of the computing devices 110, servers 120, SaaS platforms 130, entity systems 190, and electronic security platform 150 can also be equipped with one or more transceiver devices, one or more computer storage devices 101 (e.g., RAM, ROM, PROM, SRAM, etc.), and one or more processing devices 102 that are capable of executing computer program instructions.

The one or more processing devices 102 may include one or more central processing units (CPUs), one or more microprocessors, one or more microcontrollers, one or more controllers, one or more complex instruction set computing (CISC) microprocessors, one or more reduced instruction set computing (RISC) microprocessors, one or more very long instruction word (VLIW) microprocessors, one or more graphics processor units (GPU), one or more digital signal processors, one or more application specific integrated circuits (ASICs), and/or any other type of processor or processing circuit capable of performing desired functions. The one or more computer storage devices 101 can include (i) non-volatile memory, such as, for example, read only memory (ROM) and/or (ii) volatile memory, such as, for example, random access memory (RAM). The non-volatile memory can be removable and/or non-removable non-volatile memory. Meanwhile, RAM can include dynamic RAM (DRAM), static RAM (SRAM), etc. Further, ROM can include mask-programmed ROM, programmable ROM (PROM), one-time programmable ROM (OTP), erasable programmable read-only memory (EPROM), electrically erasable programmable ROM (EEPROM) (e.g., electrically alterable ROM (EAROM) and/or flash memory), etc. In certain embodiments, the computer storage devices 101 can be physical, non-transitory mediums.

In certain embodiments, the computing devices 110 may represent desktop computers, laptop computers, mobile devices (e.g., smart phones, personal digital assistants, tablet devices, vehicular computing devices, wearable devices, and/or any other device that is mobile in nature), and/or other types of devices. The one or more servers 120 may generally represent any type of computing device, including any of the computing devices 110 mentioned above. In certain embodiments, the one or more servers 120 comprise one or more mainframe computing devices, one or more cloud servers, and/or one or more virtual servers. Additionally, the one or more servers 120 may also comprise web servers for communicating with the computing devices 110, SaaS platforms 130, entity systems 190, and/or other applications and devices over the network 105 (e.g., over the Internet).

In certain embodiments, system 100A may include one or more entity systems 190. Each entity system 190 may be affiliated with an organization, business, or other entity, and may include various computing systems, networks, and/or devices (e.g., such as computing devices 110, servers 120, etc.) that are utilized by the organization's users. The technological infrastructure utilized by each entity system 190 can vary greatly. In some cases, an entity system 190 may include a sophisticated enterprise system designed for usage by large numbers of end-users across various organizational departments, such as research and development, information technology (IT), sales, legal, accounting, ecommerce, administrative, human resources, and/or other departments. In other cases, an entity system 190 may comprise less sophistical technological infrastructure (e.g., comprising computing devices 110 and/or servers 120 connected over a LAN).

In some embodiments, an entity system 190 may comprise, or communicate with, various subsystems including, but not limited to, an ERP (enterprise resource planning) system, CRM (customer relationship management) system, a SCM (supply chain management) system, an accounting and financial management system, an IMS (identify management system) 191, and/or a HRIS (human resource information system) 192. In some scenarios, some or all of the subsystems can be integrated with an entity system 190 (e.g., hosted on servers maintained by the entity system 190, included within a private network associated with the entity system 190, and/or stored in a private cloud associated with the entity system 190). Additionally, or alternatively, an entity system 190 may utilize one or more SaaS platforms 130 to integrate the functionalities of some or all of these subsystems into an organization.

In general, the IMS 191 associated with an entity system 190 can include one or more applications that provide policies, processes, and technologies aimed at managing digital identities of users within an organization and/or implementing access controls on users or assets 135 of the organization. Along these lines, the IMS 191 can execute a variety of functions relating to user provisioning, user authentication, identity governance and compliance, directory services, identity federation, privileged access management, etc. In some configurations, an IMS 191 facilitates the secure and efficient management of user identities, access privileges, and permissions across various systems, applications, and resources within an organization's information technology (IT) environment. The IMS 191 aims to ensure that the proper individuals have appropriate access to the designated resources at the right time, and conversely to prevent unauthorized access to certain assets 135. In this manner, the IMS 191 helps enhance security, enforce compliance, streamline user access workflows, and improve overall operational efficiency

Amongst other things, the IMS 191 can store identity information that can be utilized to verify a user's identity and role within the organization, including data that identifies the name, job title, organization department, role, and/or supervisor(s) of each user. The IMS 191 can also store contact information (e.g., mobile phone numbers, email addresses, etc.) for each user which can be utilized to send verification notifications to the user in the event that security concerns are detected.

In general, the HRIS 192 can include a software solution designed to streamline and automate various HR-related tasks and processes within an organization. Examples of an HRIS 192 include Oracle Cloud HCM®, Microsoft Dynamics 365®, etc. In some embodiments, the HRIS 192 stores an employee database to support human resource processes, such as payroll processing, benefits management, time management, employment status, job titles, job functions, training management, employee discipline and/or attendance.

Amongst other things, the HRIS 192 can store status information associated with each end-user (or each employee) of the organization. In some examples, the HRIS 192 may store data indicating whether a user is: 1) active (e.g., which may be applicable to users currently employed and actively working for the organization); 2) on leave (e.g., which may be applicable to users temporarily away from work due to approved leave types such as vacation, sick leave, parental leave, or sabbatical); 3) departed (e.g., which may be applicable to users who permanently left the organization, either through resignation, termination, retirement, or other reasons); 4) new (e.g., which may be applicable to users who are recently hired); 5) soon to depart (e.g., which may be applicable to users who have submitted their resignation or notice of intent to leave but are still working before departing the organization); 6) retired (e.g., which may be applicable to users who have voluntarily ended their employment with the organization due to reaching retirement age or eligibility for retirement benefits); 7) suspended (e.g., which may be applicable to users who are temporarily suspended from work pending investigation or disciplinary action for alleged misconduct or policy violations); 8) inactive (e.g., which may be applicable to users who are temporarily inactive due to reasons such as long-term disability, military service, or other circumstances where they are not actively working but remain employed); 9) on call (e.g., which may be applicable to users who are not currently working but are available to be called in for work on short notice); and/or furloughed (e.g., which may be applicable to users who are temporarily laid off from work without pay due to economic downturns, business closures, or other reasons, with the expectation of being recalled to work when conditions improve).

For various reasons or purposes, an organization (or entity system 190) may utilize software solutions provided by one or more third-party SaaS platforms 130 to supplement or streamline the operations of the organizations. The services and functions provided by each SaaS platform 130 can vary. In some examples, the SaaS platforms 130 may provide file storage services, social networking services, e-mail services, document processing services, data hosting services, enterprise business services, project collaboration services, and many other types of services. Exemplary providers of the SaaS platforms 130 may include products and/or services such as Slack®, Zoom®, Facebook®, Google Workspace®, DocuSign®, Dropbox®, Trello®, ClickUp®, Vimeo®, Amazon Web Services®, Data Dog®, Net Suite®, Twillo®, Splunk®, WebEx®, Zenefits®, Pipedrive®, Box®, Now®, and many others.

In certain embodiments, each SaaS platform 130 may host one or more applications that are made available to users over the network 105 (e.g., the Internet). In some cases, the applications offered by the SaaS platform 130 may represent web-based applications. Each SaaS platform 130 may be hosted on one or more servers (e.g., which may be the same or similar to server 120 described herein). Each SaaS platform 130 may offer separate SaaS accounts 133 to the users of an organization. In certain embodiments, in response to a user creating a SaaS account 133 on a SaaS platform 130, the SaaS platform 130 may create a separate instance of one or more applications offered by the platform and the separate instance may be associated with the account.

In many scenarios, various data assets 135 (also referred to herein as “assets”) associated with an organization (or entity system 190) may be stored on, or accessed by, one or more SaaS platforms 130 that provide software solutions to the organization and/or may be stored internally within the organization's systems and devices. The types of data assets 135 included on, or accessed by, the SaaS platforms 130 can vary greatly. Generally, the data assets 135 may relate to any type of digital content and may include any file type. For example, assets 135 may include word processing documents, images, multimedia, source code files, audio files, video files, database files, spreadsheets, portable document format (PDF) files, programs, applications, folders, directories, drives, and many other types of files or containers that include files. The data assets 135 also may include emails, instant messages, text messages, and/or other forms of digital communications. In some cases, users may import and/or upload assets 135 to the SaaS platforms 130. Additionally, some of the SaaS platforms 130 may permit users to create new assets 135 and/or edit the data assets 135. As mentioned above, each of the SaaS platforms 130 also may provide functions that enable users to share the data assets 135 and/or designate permissions for the data assets 135.

Some of the data assets 135 may include protected information 137. The protected information 137 can generally include any type of sensitive information, including, but not limited to, PII, PHI, financial information, confidential information, privileged information, proprietary information, trade secret information, legal information, etc. The protected information 137 also can include other data or information that an organization desires to limit or restrict access to, or otherwise control.

In some cases, some or all of the SaaS platforms 130 may include functionalities that permit users to upload, create, edit, and/or share data assets 135 with other users. For example, each SaaS platform 130 may permit a user to share one or more data assets 135 with internal users (e.g., employees within that user's organization) and/or external users (e.g., third parties such as vendors, collaborators, and customers). In some examples, the sharing of a data asset 135 can include providing an access link (e.g., a hyperlink) that enables an internal or external user to access the asset 135 stored on a SaaS platform 130 and/or account 133 associated with a SaaS platform 130. In other examples, the sharing of a data asset 135 can include directly sending or transmitting the asset 135, or a copy of the asset 135, to an internal or external user (e.g., such as by sending the asset through email communications, instant messaging communications, mobile text communications, FTP or file transfer protocols, and/or by other communication means).

In one example, some SaaS platforms 130 (e.g., such as Dropbox®) may permit a user to create an account that includes functions for storing and sharing data assets 135 with other users. Similarly, some SaaS platforms 130 (e.g., such a Slack®) may permit users to collaborate on shared assets 135, and/or may include functions for creating, editing, and/or deleting the assets 135. In some scenarios, the assets 135 shared using the SaaS platforms 130 may be accessed over the network 105 by other users and/or may be made publicly available on the network 105.

Traditionally, the ability of an organization to enforce DLP protections and/or other security protections on data assets 135 included on SaaS platforms 130 does not exist or is extremely limited. Many SaaS platforms 130 do not have control features that enable users to implement DLP protections on assets 135 stored on SaaS accounts 133 and, therefore, users can freely share, send, transmit, or otherwise provide access to data assets 135 containing protected information 137 both with internal and external parties.

Moreover, to the extent that a SaaS platform 130 provides security features for implementing DLP scans on assets 135 being shared, sent, or transmitted by a SaaS account 133, these features presumably would be implemented on an account-by-account basis and would not be controllable on a global level across all SaaS accounts 133 affiliated with an organization. Thus, in scenarios where an organization has large numbers of users (e.g., hundreds or thousands of users) and each user has accounts 133 with multiple SaaS platforms 130, activating and configurating such DLP controls would not be practical or possible because doing so would require security personnel to manually access and configure DLP settings for each of the SaaS accounts 133 across each of the SaaS platforms 130. Moreover, the security team would have no way of knowing whether users have deactivated or changed DLP protections on an ongoing basis.

The inability of an organization to globally enforce DLP protections of data assets 135 stored on SaaS platforms 130 weakens the organization's overall cybersecurity posture, exposes the data assets 135 to vulnerabilities, and introduces substantial risk to the organization on multiple fronts.

The functionalities provided by the electronic security platform 150 overcome these and other technical challenges associated with implementing DLP protections on data assets 135 of an organization that are stored across one or more SaaS platforms 130. Additionally, the electronic security platform 150 provides more comprehensive DLP protections via usage of the MCDLP security policies 175 described herein. As described throughout this disclosure, these MCDLP security policies 175 can more effectively assess the exposure of data assets 135 using a variety of contextual parameters and can be enforced both on data assets 135 stored on SaaS platforms 130 and on data assets 135 stored internally within an entity system 190.

As explained in further detail below, the ability of the electronic security platform 150 to receive and analyze events related to assets 135 remotely stored on SaaS platforms 130 enables the electronic security platform 150 to enforce DLP protections on those remotely stored assets 135 and, if needed, to execute remedial functions to protect exposed assets 135. In many embodiments, the electronic security platform 150 can store and execute DLP security policies that are configured to scan assets 135 that are shared or transmitted using SaaS accounts 133 for the presence of protected information 137, such as sensitive information that includes PII, PHI, financial information, etc.

Additionally, in certain embodiments, the electronic security platform 150 can store and execute MCDLP security policies 175 that provide more comprehensive DLP protections in comparison to traditional DLP scanning techniques. In addition to scanning assets 135 for protected information 137, the MCDLP security policies 175 described herein also can consider a variety of contextual parameters in assessing the risk or exposure of assets 135. In some examples, the MCDLP security policies 175 can consider a role of a user within an organization that initiated the sharing or sending of a data asset 135 and/or a current status of the user within the organization. The MCDLP security policies 175 also can provide extra protections that involve sending verification requests that prompt one or more users to verify, confirm, or approve whether a share or send attempt pertaining to a data asset 135 was authorized.

Examples of how the electronic security platform 150 implements DLP and/or MCDLP protections on data assets 135 are described in further detail below.

In certain embodiments, the electronic security platform 150 includes an integration component 160 that permits users (e.g., security personnel or administrative users) to link and/or integrate SaaS accounts 133 on SaaS platforms 130 with the electronic security platform 150. For example, upon accessing an account on the electronic security platform 150, the integration component 160 may permit the user to identify SaaS accounts 133 on one or more SaaS platforms 130 that are associated with an organization and/or users of the organization. For each identified SaaS account 133, an authorization framework may enable the integration component 160 to securely access some or all of the data associated with the SaaS account 133. In certain embodiments, the integration component 160 may communicate with one or more application programming interfaces (APIs) 132 provided by the SaaS platforms 130 to integrate the SaaS accounts 133 with the electronic security platform 150 and to access data associated with the SaaS accounts 133.

In certain embodiments, the integration component 160 can utilize OAuth 2.0 and/or other types of authorization frameworks to integrate SaaS accounts 133 and access data associated with the SaaS accounts 133. Upon linking or integrating a SaaS account 133 with the electronic security platform 150, the integration component 160 allows for bi-directional communication between the SaaS platforms 130 and the electronic security platform 150.

After a SaaS account 133 is linked to, or integrated with, the electronic security platform 150, the electronic security platform 150 can monitor and/or track all user activities and security features associated with the SaaS account 133. In some examples, the electronic security platform 150 can receive activity events 131 from the SaaS accounts 133 relating to assets 135, authenticating users, installing plugins, changing user roles or account information, changing account passwords, and/or other related features and functions that can affect the security of the SaaS account 133 or data associated with the SaaS account 133.

Various types of activity events 131 can be received and analyzed by the electronic security platform 150. The activity events 131 can generally indicate any type of activity that is conducted on or by the SaaS accounts 133. Exemplary activity events 131 can include, inter alia, share events, file events, and/or user events.

Share events can include any activity event 131 associated with sharing assets 135 and/or other data using a SaaS account 133. For example, share events may indicate that a SaaS account 133 is sharing an asset 135 and/or attempting to share an asset 135. In some examples, share events may be generated by a SaaS account 133 (or corresponding SaaS platform 130) in response to a user sending, or attempting to send, a link that enables an internal or external user to access the asset 135. In other examples, share events may be generated by a SaaS account 133 in response to a user sending or transmitting (or attempting to send or transmit) an asset 135, or a copy of the asset 135, to an internal or external user (e.g., such as by sending the asset through email communications, instant messaging communications, mobile text communications, FTP or file transfer protocols, and/or by other communication means). Share events may also be generated which indicate that a recipient user with whom an asset 135 has been shared is attempting to access, view, create, edit, and/or delete the asset 135.

File events can include any activity event 131 associated with manipulating assets 135 using a SaaS account 133. Exemplary file events can be generated in response to any or all of the following: copying files, folders, and/or directories; pasting files, folders, and/or directories; creating, editing, and/or deleting files, folders, and/or directories; renaming files, folders, and/or directories; uploading files, folders, and/or directories; downloading files, folders, and/or directories and/or moving or changing locations of files, folders, and/or directories.

User events can include any activity event 131 associated with manipulating details of a SaaS account 133, designating privileges of a SaaS account 133, and/or manipulating user groups associated with a SaaS account 133. Exemplary user events can be generated in response to any or all of the following: changing user roles associated with SaaS accounts (e.g., designating administrator roles to user accounts); creating, editing, and/or deleting user groups; approving or denying user requests; changing passwords associated with SaaS accounts; changing contact information associated with SaaS accounts; adding and/or removing users from user groups or teams; and/or changing user statuses (e.g., invited, joined, suspended, terminated, etc.).

Many other types of activity events 131 can be generated by the SaaS accounts 133 and/or SaaS platforms 130. For example, activity events 131 also may indicate that a plugin has been installed and/or that a plugin is attempting to access assets 135 and/or other content associated with a SaaS account 133. Activity events 131 also may indicate whether or not a user utilized one or more authentication protocols (e.g., MFA) to access a SaaS account 133 and/or asset 135 associated with a SaaS account 133. Activity events 131 also may indicate that a user is attempting to install or uninstall a script, add-on, application, and/or other software that interacts with a SaaS account 133.

Each activity event 131 may include metadata that provides information related to the action or attempted action being undertaken by a corresponding SaaS account 133. For example, in response to a user attempting to share an asset 135 via a SaaS account 133, an activity event 131 (e.g., a share event) may be generated that includes metadata identifying the SaaS account 133 and/or user attempting to share the asset 135, an identifier indicating or identifying the asset 135 that is attempted to be shared, access privileges associated with sharing the asset 135 (e.g., indicating whether public vs. limited user access was specified and/or whether an expiry date has been specified for accessing the file), a timestamp indicating when the event was created, and/or one or more intended recipients of the asset 135. Similarly, after an asset 135 has been shared, subsequent activity events 131 may be generated in response to recipient users accessing, viewing, editing, and/or deleting the asset 135. Each activity event 131 may include corresponding metadata (e.g., identifying the recipient user who is attempting to access the asset 135, indicating the type of activity being attempted, and a timestamp associated indicating when the event was initiated).

All activity events 131 associated with assets 135 being shared may be received by the electronic security platform 150. In certain embodiments, web hooks provided by, or accessible through, each of the SaaS platforms can be configured to automatically transmit the activity events 131 to the electronic security platform 150. Additionally, or alternatively, the electronic security platform 150 may periodically poll the APIs 132 of the SaaS platforms 130 and/or SaaS accounts 133 to pull and retrieve the activity events 131. Regardless of how the activity events 131 and corresponding metadata are provided to the electronic security platform 150, the activity events 131 and corresponding metadata may be analyzed by a data loss prevention (DLP) system 170 to enforce DLP security policies, including MCDLP security policies 175, pertaining to the SaaS accounts 133 and/or assets 135 associated with the SaaS accounts 135, as explained in further detail below.

The DLP system 170 may permit users (e.g., administrative or security users) to define MCDLP security policies 175 across multiple SaaS accounts 133 and/or assets 135 stored across multiple SaaS platforms 130, and to enforce the MCDLP security policies 175 across the SaaS platforms 130 and SaaS accounts 133. In certain embodiments, after a user has accessed an account on the electronic security platform 150 (e.g., by logging in with a username and password) and applicable SaaS accounts 133 are linked to the electronic security platform 150, one or more graphical user interfaces (GUIs) provided by the DLP system 170 (or by the electronic security platform 150) may enable the user to define MCDLP security policies 175 for implementing security features on the SaaS accounts 133 to handle protected information 137 and/or assets 135 subject to DLP policies.

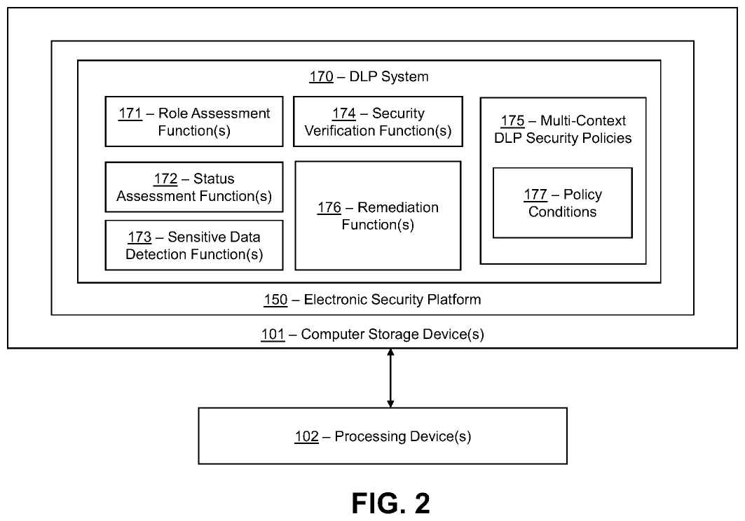

Generally, an MCDLP security policy 175 may include a policy condition (177 in FIG. 2) or a collection of policy conditions for securing and/or controlling access to protected information 137 and/or data assets 135 that include protected information 137. In many examples, an MCDLP security policy 175 may include policy conditions for analyzing multiple contextual parameters to ensure the safety of data assets 135 comprising protected information 137.

In some examples, an MCDLP security policy 175 can include a first policy condition identifying a type of activity event 131 to which the MCDLP security policy 175 applies. For example, the first policy condition may indicate that the MCDLP security policy 175 applies to activity events 131 that involve sharing, sending, transmitting, or providing access to data assets 135.

An MCDLP security policy 175 also can include a second policy condition specifying that the policy applies to end-users having certain roles. In certain embodiments, the security enforcement platform 150 and/or DLP system 170 can communicate with an IMS 191 and/or other subsystem associated with the organization to obtain the identities and/or roles of one or more users associated with an activity event 131 and utilize this information to evaluate whether one or more MCDLP security policies 175 apply to the activity event 131. For example, the second policy condition may indicate MCDLP security policy 175 applies to activity events 131 that originate from (or are directed to) users associated with designated roles in an organization. In some scenarios, users having certain roles (e.g., finance or accounting roles) in an organization may have access to various types of protected information 137 and specific MCDLP security policies can be targeted to review activity events 131 (e.g., sharing events) originating from those users to ensure that the protected information 137 is handled securely.

An MCDLP security policy 175 also can include a third policy condition that evaluates a status of a user associated with (e.g., initiated by or directed to) an activity event 131. In certain embodiments, the security enforcement platform 150 and/or DLP system 170 can communicate with an HRIS 191 and/or other subsystem associated with the organization to obtain the status data for one or more users associated with an activity event 131 and utilize this information to evaluate whether the activity event 131 (e.g., a share attempt) is authorized based on the third policy condition. As explained above, the status of the user may indicate, inter alia, whether the user is active, suspended, departed, etc. In some scenarios, the third policy condition may limit or restrict certain types of activity events 131 from being performed or executed based on the statuses of one or more users associated with the activity event 131.

Thus, in some examples, the third policy condition can identify activity events 131 that originate from users (or corresponding user accounts) who are associated with designated status indicators that are suspicious in nature (e.g., departed, soon to depart, etc.). In some scenarios, the third policy condition can be useful to prevent unauthorized access to protected information 137 by a departed user (even if the departed user's accounts have not yet been deactivated or the permissions of the departed user have not yet been revoked). Likewise, in some scenarios, the third policy condition can be useful to prevent authorized access to protected information 137 by a user that is in the process of leaving the organization (e.g., such as to prevent that user from stealing trade secrets, customer lists, or other protected information 137 before exiting the organization).

An MCDLP security policy 175 also can include a fourth policy condition that identifies a type of protected information 137 associated with a MCDLP security policy 175. In some examples, the fourth policy condition may indicate that the MCDLP security policy 175 applies to PII data and the MCDLP security policy 175 may cause a data asset 135 identified by an activity event 131 to be scanned for PII information. In some examples, the fourth policy condition may indicate that the MCDLP security policy 175 applies to PHI data and the MCDLP security policy 175 may cause a data asset 135 identified by an activity event 131 to be scanned for PHI information. In some examples, the fourth policy condition may indicate that the MCDLP security policy 175 applies to all types of protected information 137 (e.g., PII, PHI, financial information, etc.) and the MCDLP security policy 175 may cause a data asset 135 identified by an activity event 131 to be scanned for all types of protected information 137.

The MCDLP security policy 175 also can include a fifth policy condition that elicits a verification from one or more users associated with an activity event 131. In some examples, the fifth policy condition can cause a verification request to be transmitted in response to the DLP system 170 detecting that a share event (or other activity event) involves the sharing or sending of protected information 137. In some cases, the verification request can be a “self-verification” request that is sent to the user that initiated the activity event 131 (e.g., such as to confirm the account of the user is not being accessed by a malicious or unauthorized user). Additionally, or alternatively, the verification request can be sent to security personnel, IT personnel, managers, supervisors, and/or other users.

The MCDLP security policies 175 described herein can be adapted to consider a variety of additional policy conditions and parameters (in addition to those mentioned above) in assessing DLP protections relating to data assets 135 and/or the context of activity events 131. Additionally, as explained below, the MCDLP security policies 175 can execute or enforce a variety of remedial actions in the event that unauthorized access to data assets 135 having protected information 137 is detected or suspected.

In some embodiments, designated users (e.g., security personnel, administrators, supervisors, etc.) of an organization may be permitted to access the security enforcement platform 150 to define the MCDLP security policies 175 and other security policies described herein. In some examples, the security enforcement platform 150 may present these users with one or more GUIs, which allow the users to specify and customize desired policy conditions for the MCDLP security policies 175. The ability to customize and define the MCDLP policies 175 with various policy conditions (and different settings for each policy condition) enables an organization to implement and enforce DLP protections at a granular level across various departments or user groups within the organization.

In some examples, at least some of the policy conditions associated with an MCDLP security policy 175 can operate to perform filtering on activity events 131. For instance, using a GUI presented via the security enforcement platform 150, an MCDLP security policy 175 may be customized or defined to address one or more particular types of activity events 131 (e.g., such as share events that involve emailing data assets 135, share events that involve providing a link to access to data assets 135, etc.). In other examples, policy conditions (or corresponding filters) can be applied to user identities (e.g., to direct an MCDLP security policy 175 to one or more users, one or more user roles, one or more groups or types of users, etc.). In some instances, a user's email address (or domain associated therewith) may determine whether or not the user is subject to an MCDLP security policy 175.

In further examples, a GUI presented via the security enforcement platform 150 also may enable the user to specify the types of protected information 137 that are subject to the MCDLP security policy 175 and/or which types of assets are subject to the MCDLP security policy 175. For example, non-encrypted files or assets may be subjected to an MCDLP security policy 175, while encrypted files or assets may not be subject to an MCDLP security policy 175. Date ranges and/or time ranges also may be considered in customizing an MCDLP security policy 175.

Using the GUIs presented via the security enforcement platform 150, a user may specify and associate these and other policy conditions with an MCDLP security policy 175. In addition, the GUIs presented via the security enforcement platform 150 may enable a user to specify one or more remedial actions to be enforced or executed if and/or when a MCDLP security policy 175 is violated. Further, the GUIs presented via the security enforcement platform 150 may enable a user to specify whether security verification requests are required for compliance with the MCDLP security policy 175 and/or to whom those verification requests are to be sent.

Although certain portions of this disclosure describe embodiments in which the electronic security platform 150 and DLP system 170 provide DLP protections for data assets 135 located on SaaS platforms 130, it should be understood the techniques described herein can by implemented across a wide variety of systems and can provide DLP protections for data assets 135 stored in any location. For example, as discussed in further detail below, the MCDLP security policies 175 can be implemented internally within enterprise systems and/or on data assets 135 that are stored within an entity system 190 (e.g., within an organizations private network and/or private could system).

FIG. 1B is a block diagram of exemplary system 100B that illustrates how the security enforcement platform 150 (and DLP system 170) can be integrated within an enterprise system 195 affiliated with an organization according to certain embodiments. In this system 110B, at least a portion of the data assets 135 are stored internally within the enterprise system 195 (and not on third-party SaaS platforms 130) and the electronic security platform 150 monitors activity events 131 (e.g., share events, file events, user events, etc.) that arise internally within the system 100B.

In some cases, the enterprise system 195 may store data assets 135 in one or more data systems 136. The one or more data systems 136 may comprise one or more DMSs (document management systems), one or more CMSs (content management systems), one or more file servers, one or more cloud storage servers, one or more content collaboration systems, one or more DAM (digital asset management) systems, one or more KMSs (knowledge management systems), and/or other systems that are capable of storing data assets 135.

The users operate a computing device 110 to access entity user accounts 193 (e.g., enterprise accounts) associated with the enterprise system 195. In some embodiments, the IMS 191 and/or other component of the enterprise system 195 can delegate or provision access rights to the entity user accounts 193. The entity user accounts 193 may enable the users to access various data assets 135 stored within the enterprise system 195 and/or stored on the computing devices 110 associated with the enterprise system 195. The entity user accounts 193 can further enable the users to share access to the data assets 135 with both internal users and external users (e.g., by sharing links to access the data assets 135, transmitting the data assets 135 via email or other communication protocols, etc.).

When a user interacts with data assets 135 stored within the enterprise system (within one or more of the data systems 136), the same types of activity events 131 (and corresponding metadata) may be generated as described above and these activity events 131 may be received, or accessed, by the electronic security platform 150. In the same manner described above, the electronic security platform 150 may analyze the activity events 131 and apply DLP security policies, including MCDLP security policies 175, to secure protected information 137 included in the data assets 135.

In scenarios where an end-user or entity user account 193 attempts to share a data asset 135 in a manner that violates one or more MCDLP policies 175, the security enforcement platform 150 can execute one or more remediation actions 170, e.g., such as to prevent or revoke access privileges to data assets 135 that comprise protected information 137. In doing so, the security enforcement platform 150 may send commands internally with the network 105 of the entity system 190 (or enterprise system 195) to the entity user accounts 193 and/or subsystems (e.g., data systems 136) to secure or protect the data assets 135 from unauthorized access.

As discussed in further detail with respect to FIGS. 2-4, the DLP system 170 may include various components that are configured to execute functions to enforce MCDLP security policies 175 in connection with protecting the data assets 135 associated with an entity system 190, regardless of whether those data assets 135 are stored remotely on SaaS platforms 130 and/or internally within the entity system 190.

FIG. 2 illustrates a block diagram of a DLP system 170 in accordance with certain embodiments. In this exemplary embodiment, the DLP system 170 can store and execute role assessment functions 171, status assessment functions 172, sensitive data detection functions 173, and/or security verification functions 174 to detect whether activity events 131 (e.g., such as share events) violate or comply with predefined MCDLP security policies 175 stored on security enforcement platform 150. Each of these functions can consider a separate contextual factor for evaluating the activity events 131 and consideration of these contextual factors in combination can provide more comprehensive DLP analyses associated with assessing the risk or exposure of data assets 135. In the event that an activity event 131 is determined to violate one or more MCDLP security policies 175, the DLP system 170 may execute one or more remediation functions 176 to prevent unauthorized access to protected information 137 and/or to correct or remediate access to the protected information 137.

In general, the role assessment function 171 can be configured to analyze a role of a user associated with an activity event 131 based on a policy condition 177 specified in a MCDLP security policy 175. In some examples, the role assessment function 171 may retrieve or analyze the role of a user that initiated the activity event 131, such as by sharing or sending a data asset 135. The role of the user in this context may be a factor that is used to determine whether or not the sharing or sending of the data asset 135 was authorized by, or falls within the scope of, one or more MCDLP security policies 175.

In some scenarios, analyzing the role of the user can be utilized to detect suspicious activity events 131 and/or to detect whether the activity events 131 violate established MCDLP security policies 175. The role assessment function 171 may also determine if the activity event 131 is typical or authorized for a user having the determined role based on the policy conditions set forth in or more MCDLP security policies 175 (e.g., such as when a user is sharing data assets 135 that are not typically associated with the user's role). In one example, a MCDLP security policy 175 may specify that users associated a financial department role are permitted to share data assets 135 containing sensitive financial information, but users associated with a sales department are not. In another example, a MCDLP security policy 175 may specify that a user associated with an HR department or a secretarial role are not permitted to share data assets 135 that include any type of sensitive information. Thus, when an activity event 131 is being analyzed by the electronic security platform 150, the role assessment function 171 executed by the DLP system 170 may retrieve and analyze the role of users associated with the activity event 131 as part of an evaluation that determines whether or not the activity event 131 is authorized and/or in compliance with one or more MCDLP security policies 175.

In certain embodiments, role assessment function 171 may access or communicate with an entity system 190 and/or IMS 191 in order to retrieve and/or determine a role associated with the users. In some embodiments, the role assessment functions 171 may cause the user to authenticate themselves to entity system 190 and/or IMS 191. In certain embodiments, roles may be stored in a portion of server 120 (e.g., in a database) and accessed or retrieved in order to determine a role associated with a user.

The DLP system 170 also may store and execute a status assessment function 172 that analyzes status data for users associated with activity events 131 and compares the status data for the users to a policy condition 177 of a MCDLP security policy 175. As explained above, the status data associated with a user may indicate if a user is a departed user (e.g., resigned, terminated, laid-off, etc.), a suspended user, a user on leave, etc. Analyzing the status of the user associated with an activity can be utilized to detect suspicious activity events 131 and/or to detect whether the activity events 131 violate established MCDLP security policies 175. In one example, one or more policy conditions 177 set forth in a MCDLP policy 175 may specify that departed users are not permitted to share or send data assets 135 comprising protected information 137 (or any data assets 135 generally). In another example, the policy conditions 177 for an MCDLP policy 175 may specify that users with “soon to depart” statuses are not permitted to share or send data assets 135 that include proprietary intellectual property and/or other types of protected information 137 (e.g., to prevent trade secret theft). Thus, when an activity event 131 is being analyzed by the electronic security platform 150, the status assessment function 172 executed by the DLP system 170 may retrieve and analyze the status data of users associated with the activity event 131 as part of an evaluation that determines whether or not the activity event 131 is authorized and/or in compliance with one or more MCDLP security policies 175.

In certain embodiments, the status assessment function 172 may access or communicate with an entity system 190 and/or HRIS 192 in order to determine a status of the users associated with an activity event 131. In some embodiments, the status assessment function 172 may cause the users to authenticate themselves to entity system 190 and/or HRIS 192. In certain embodiments, user status data may be stored in a portion of server 120 (e.g., in a database) and accessed by the status assessment function 172 in order to determine a status associated with a user. The status assessment function 172 may determine if a user status is incompatible with an activity event 131 under analysis of an MCDLP security policy 175.

The DLP system 170 also may store and execute one or more sensitive data detection functions 173 based on a policy condition 177 set forth in an MCDLP policy 175. A sensitive data detection function 173 can generally relate to a function that scans or analyzes a data asset 135 to determine whether or not the data asset 135 comprises protected information 137. The sensitive data detection function 173 can be configured to detect various types of protected information 137 including, but not limited to: personally identifiable information (PII), payment card information (PCI), personal healthcare (PHI), data subject to one or more security clearances, intellectual property data, attorney-client privileged data, proprietary data, etc.

In some examples, a policy condition 177 in an MCDLP policy 175 can indicate that a data asset 135 corresponding to an activity event 131 is to be scanned or analyzed for all types of protected information 137 and/or is to be scanned or analyzed for specific types of protected information 137. When an activity event 131 is being analyzed by the DLP system 170, the sensitive data detection function 173 executed by the DLP system 170 may analyze a data asset 135 associated with the activity event 131 to detect whether or not the data asset 135 comprises protected information 137 as part of an evaluation that determines whether or not the activity event 131 is authorized and/or in compliance with one or more MCDLP security policies 175.

The sensitive data detection functions 173 can utilize various technologies or techniques to detect protected information 137 included in data assets 135. In some examples, the sensitive data detection functions 173 can utilize regex (regular expressions) functions to detect patterns or formats of data known to be sensitive (e.g., such as social security numbers, employer identification numbers, etc.). Additionally, or alternatively, the sensitive data detection functions 173 can utilize keyword matching, data classification functions, contextual analysis functions, checksum or hashing functions, and/or pattern recognition functions to determine whether protected information 137 is present in data assets 135. Other techniques also may be utilized.

In some examples, the sensitive data detection function 173 utilizes one or more of the above techniques to scan a data asset 135 associated with an activity event 131 for protected information 137 based on policy conditions 177 set forth in an MCDLP policy 175. If the data asset 135 is an aggregate asset 135 (e.g., a directory, archive file, compressed folder, etc.), an MCDLP security policy 175 may scan one or all assets 135 included in the aggregate asset 135 for protected information 137. Generally, sensitive data detection function 173 may scan one or more assets 135 for all identifiable types of protected information 137 present in the asset 135. However, if one or more particular types of protected information 137 are specified by the MCDLP security policy 175, sensitive data detection function 173 may scan for and identify only the particular types of protected information 137 specified.

The DLP system 170 also may store and execute one or more security verification functions 174. In general, a security verification function 174 can be configured to transmit security verification requests to (e.g., verification request 345) to one or more users to verify an activity event 131 (or to verify the sharing or sending of a data asset 135 associated with the activity event 131). The security verification function 174 also can be configured to receive security verification responses (e.g., verification response 346) from users who respond to the security verification requests.

The MCDLP security policies 175 stored by the DLP system 170 may include policy conditions 177 requiring security verification requests to be transmitted in certain scenarios, identifying one or more users to receive the security verification requests, and/or specifying a time period for receiving verification responses corresponding to the verification requests. In some examples, a MCDLP policy 175 may specify that “self-verification” security verification requests should be transmitted to users that originated the activity event 131 (e.g., the users who shared or sent a data asset 135) to verify that their accounts are not to be accessed by unauthorized users. In other examples, the MCDLP policy 175 may specify that “supervisory” security verification requests should be transmitted to security personnel (e.g., IT users, cybersecurity users, etc.) or managers to confirm whether or not the sharing or sending of data assets 135 in an activity event 131 is authorized. The users who receive the security verification requests may then transmit security verification responses, which confirm or deny the sharing or sending of data assets 135 associated with the activity event 131.

In some cases, a policy condition 177 may require that a security verification response be received within a predetermined time period in order for a corresponding activity event 131 to be authorized. In the event that a response is not received or is received after expiration of the time period, then the activity event 131 may be deemed to be in violation of the corresponding MCDLP policy 175.

The security verification requests can include various types of content and/or can be transmitted using various types of communication techniques. In some examples, a security verification request and/or a security verification response to a security verification request may include one or more prompts, one or menu choices, and/or selectable items which permit recipients to confirm or deny sharing or sending of data assets 135 comprising protected information 137. Additionally, the security verification requests may be transmitted to, and accessed by users through inboxes or messaging features provided on accounts of one or more SaaS platforms 130. Additionally, or alternatively, the security verification requests may be transmitted to, and accessed by users through, e-mail, inboxes accessible via the electronic security platform 150 or SaaS accounts 133, text messages, app notifications, instant messaging systems, and/or other electronic messaging means. The responses to the security verification requests can be transmitted using the same techniques.

In certain embodiments, a security verification request may request feedback from a recipient to specify a reason for an action associated with an activity event 131 (e.g., a business context or other explanation). In certain embodiments, a confirmation contained in a security verification response may or may not authorize an action associated with an activity event 131. For example, in some cases, pre-processing or post-processing steps may be taken to authorize an action associated with an activity event 131.

In some examples, a security verification request may be sent to the user immediately after the security verification function 174 detects that the user has initiated an activity event 131 (e.g., share event) that involves a data asset 135 that includes protected information 137. In other examples, a security verification request may be sent to a user periodically (e.g., daily, weekly, monthly, etc.) which identifies applicable activity events 131 initiated by the user during a recent time period.

In some particularly useful scenarios, each security verification request may identify one or more share events associated with a user. Each security verification request may include various information associated with each share event, e.g., such as information indicating one or more recipients of the share event, a date and time the share event was generated, a SaaS platform 130 or SaaS account 133 that was used to initiate the share event, one or more assets 135 that were shared, sharing privileges (e.g., public vs. private) associated with the share event, and/or other related information. Some or all of this information included in the security verification request may be extracted from metadata associated with the share event.

Users can review the information in a security verification request to determine if activity events 131 initiated from their SaaS accounts were authorized and valid, and to identify instances where accounts were potentially hacked or misused. Users also can review the information included in a security verification request to determine if the parameters of an intended activity were properly specified (e.g., appropriate privileges were specified, appropriate recipients were specified, intended files were shared, etc.).

For each activity event 131 (e.g., share event) identified in a security verification request, options may be provided that enable a user to approve or deny the activity event. If a user selects an approval option, a message can be transmitted to the electronic security platform 150 (e.g., to the security verification function 174 or DLP system 170) indicating that the corresponding activity event 131 (e.g., share event) was approved by the user. In some embodiments, upon receiving an approval message, the electronic security platform 150 may allow the underlying activity event 131 provided that other policy conditions 177 associated with an MCDLP policy 175 are satisfied. If a user selects a denial option, a message can be transmitted to the electronic security platform 150 to remediate the activity event 131. For example, upon receiving a denial message, the electronic security platform 150 can remediate the underlying activity event 131 (e.g., share event, file event, user event), deny access to any files or data associated with a share event, and/or prohibit activities associated with the activity event 131. In some scenarios, electronic security platform 150 may communicate with a SaaS platform 131 associated with the underlying activity event 131 to perform a remediation action.

In certain embodiments, DLP system 170 may store and execute various types of remediation functions 176 for protecting or securing the data assets 135 and/or protected information 137 associated with the data assets 135. In general, a remediation function 176 can include a function that is configured to prevent unauthorized access to protected information 137 and/or to correct or remediate unauthorized access that already has been granted to the protected information 137.

Exemplary remediation functions 176 can include actions such as: removing, revoking, and/or modifying sharing permissions associated with one or more data assets 135; preventing or restricting access to one or more data assets 135; removing, revoking, and/or modifying public or private sharing permissions associated with one or more data assets 135; enforcing constraints that prevent one or more external users and/or one or more internal users from accessing one or more data assets 135; removing, revoking, and/or modifying certain types of file permissions (e.g., reading, writing, or executing privileges) associated with one or more data assets 135; un-sending a communication (e.g., an email or other types of digital communications) that includes one or more data assets 135; and/or preventing a communication or link from being transmitted; encrypting one or more data assets 135 to prevent unauthorized access to protected information 137 within the one or more data assets 135; transmitting notifications to one or more security users; quarantining, isolating, or segregating one or more data assets 135; and/or redacting protected information 137 included in one or more data assets. Many other types of remediation functions 176 can be executed to safeguard the data assets 135 and/or protected information 137 associated with the data assets 135.

The security enforcement platform 150 can be configured to perform remediation functions 176 on data assets 135 that are remotely stored on one or more SaaS platforms 130. In some examples, the security enforcement platform 150 may transmit commands over a network 105 to one or more SaaS platforms 130 (e.g., via APIs 132) that cause one or more remediation functions 176 to be enforced on data assets 135 associated with one or more SaaS accounts 133 integrated with the security enforcement platform 150. Additionally, or alternatively, the security enforcement platform 150 can be configured to perform remediation functions 176 on data assets 135 stored internally or locally within an entity system 190 (e.g., within an enterprise system 195 and/or within one or more data systems 136). In some examples, the security enforcement platform 150 may transmit commands within an internal network 105 that cause one or more remediation functions 176 to be enforced on data assets 135 associated with user accounts (e.g., enterprise user accounts) and/or stored in one or more data systems 136.

In various scenarios, the security enforcement platform 150 can execute one or more remediation functions 176 on data assets 135 (stored on locally or remotely) in response to detecting that one or more MCDLP security policies 175 have been violated and/or in response to detecting that one or more policy conditions 177 associated with the MCDLP security policies 175 have been violated. In some cases, the particular types of remediation functions 176 that are executed can be defined by, or associated with, the MCDLP security policies 175. For example, a MCDLP policy 175 that is designed to prevent data loss associated with sharing protected information 137 with external users may include a policy condition 177 indicating that all sharing privileges granted to external users should be revoked (or prevented before being granted). Additionally, or alternatively, the MCDLP policies 175 can include policy conditions 177 indicating that emails containing protected information 137 should be unsent and/or that protected information 137 should be redacted automatically before sending data assets 135 that include the protected information 137.

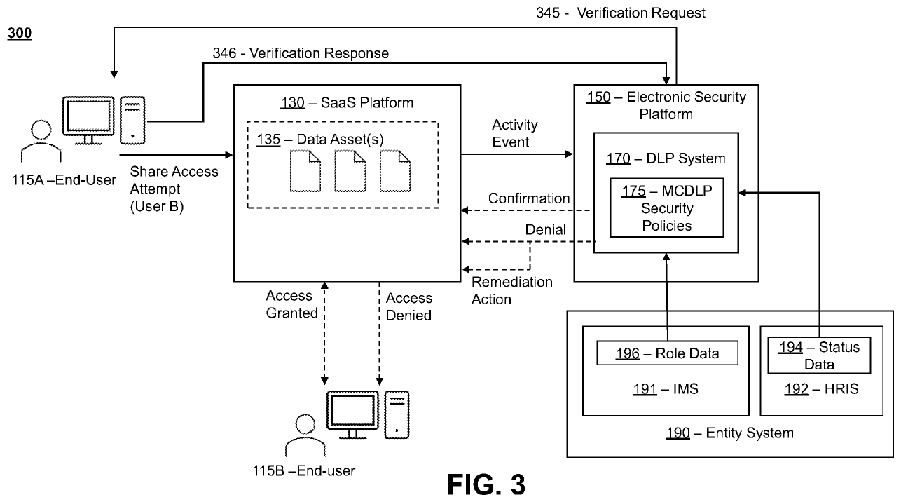

FIG. 3 is an exemplary process flow 300 for employing MCDLP according to certain embodiments. This exemplary process flow 300 demonstrates, inter alia, how one or more MCDLP policies 175 can be enforced on an activity event 131 that involves sharing a data asset 135 that is remotely stored on a SaaS platform 130.

In this example, end-user 115A initiates an action in connection with SaaS platform 130. For example, end-user 115A having a SaaS account 133 may attempt to share one or more assets 135 stored on a SaaS platform 130 with a second end-user 115B. In response, an activity event 131 (e.g., share event) is generated by the SaaS platform 130 and/or the SaaS account 133 associated with end-user 115A, and the activity event 131 is received by electronic security platform 150. The activity event 131 may be communicated to the electronic security platform 150 via any means (e.g., using a web hook or polling technique as discussed above). Additionally, the activity event 131 may include various metadata related to the activity event 131 (e.g., metadata identifying the data assets 135 attempted to be shared, the end-user 115A who initiated the activity event 131, the end-user 115B with whom the data assets 135 are being shared, the type of activity event 131, the SaaS platform 130 where the data asset 135 is stored, the SaaS account 133 associated with the end-user 115A, etc.).

In some embodiments, the electronic security platform 150 may pre-process the activity event 131 prior to providing the activity event 131 to DLP system 170. DLP system 170 may then analyze information associated with activity event 131 in conjunction with one or more MCDLP security policies 175. In some scenarios, the DLP system 170 may initially determine if the type of activity event 131 is subject to at least one of the MCDLP security policies 175. For example, DLP system 170 may determine if the activity event 131 corresponds to a share event that involves sharing or providing access to one or more data assets 135 (e.g., which involves sharing access to a cloud storage directory, sharing a link to data assets 135, transmitting a data asset 135 by email or other communication means, etc.). In response to detecting that the activity event 131 involves sharing or providing access to one or more data assets 135, the DLP system 170 may analyze the activity event 131 using an applicable MCDLP security policy 175 (or multiple MCDLP security polices 175).

The analysis performed by enforcing the MCDLP security policy 175 causes multiple contextual parameters associated with the activity event 131 (and/or data assets 135 related to the activity event 131) to be assessed or analyzed. As explained below, the security enforcement platform 150 can communicate with various components of an entity system 190 to ascertain and analyze these contextual parameters.

In some embodiments, the MCDLP security policy 175 may consider a first contextual parameter related to a role of one or more users (e.g., initiating end-user 115A or recipient end-user 115B) associated with the activity event 131. To ascertain the role of the end-user 115A, the DLP system 170 may analyze identities of the end-users. For example, in the context of a sharing event, DLP system 170 may ascertain the identity of the end-user 115A sharing the asset 135 and/or the identity of the end-user 115B to whom the asset is shared. The metadata associated with activity event 131 may include information (e.g., an e-mail address, SaaS account information, a user ID, etc.) identifying the end-user 115A sharing the asset 135 and/or identifying the end-user 115B to whom the asset is shared. The identities of the users may be utilized to query an entity system 190 (e.g., an IMS 191) to ascertain role data 196 identifying the roles associated with the users.

After the role data 196 is retrieved, DLP system 170 may compare the roles of one or more of the users to a policy condition 177 in the MCDLP security policy 175. In some scenarios, a MCDLP security policy 175 may be defined to enforce DLP protections on sharing events initiated by users with particular roles (e.g., users in a finance department or financial role that have access to sensitive financial data). In this scenario, the role of the end-user 115A who initiated that share event may be analyzed to determine if the MCDLP security policy 175 applies to the detected share event. If the role matches a role condition identified by the MCDLP security policy 175, then it may be determined that the MCDLP security policy 175 applies and other policy conditions 177 of the MCDLP security policy 175 may be assessed.

In some embodiments, the MCDLP security policy 175 may consider a second contextual parameter related to a status of one or more end-users (e.g., initiating end-user 115A and/or recipient end-user 115B) associated with the activity event 131. In certain embodiments, DLP system 170 may communicate with an entity system 190 (e.g., an HRIS 192) to access status data 194 for the end-users associated with the activity event 131. As described above, for each user that is a member of an organization, the status data 194 may indicate if each user is departed, suspended, soon to be departed, active, etc. In some examples, the MCDLP security policy 175 may specify one or more statuses that are suspicious (e.g., departed or soon to be departed) and/or which may cause security concerns. The status conditions specified in the MCDLP policy 175 may be compared to the status data 194 obtained from the entity system 190 to determine if the activity event 131 is suspicious or raises security concerns.

In some cases, if the end-user 115A that initiated the activity event 131 has an unapproved status as identified by a MCDLP policy 175, one or more remediation functions 176 may be executed (e.g., such as to prevent access to a data asset 135 attempting to be shared and/or to revoke or restrict permissions associated with the accessing the data asset 135).

In certain embodiments, the MCDLP policy 175 may include a policy condition 177 that causes the data asset 135 associated with the activity event 131 to be scanned or analyzed to detect whether the data asset 135 comprises protected information 137 (or specific types of protected information 137). As discussed above, determining whether an asset 135 contains protected information 137 may be performed using sensitive data detection function 173 of DLP system 170. In many cases, if it is determined that the asset 135 that is the subject of an activity event 131 does not contain protected information 137, DLP system 170 may determine that the activity event complies with the MCDLP security policy 175 and no remedial action may be required. Conversely, if it is determined that the asset 135 contains protected information 137 (or specific types of protected information 137 identified by the MCDLP policy 175), DLP system 170 may determine that remedial action is required and/or further analysis of the activity event 131 is required. Typically, when protected information 137 is determined to be present in an asset 135 that is a subject of an activity event 131, other policy conditions 177 in the MCDLP security policy 175 will specify whether remedial action is required (e.g., user role or status incompatibility or security verification request failure). As discussed above, such remediations may be performed using remediation functions 176 of DLP system 170. In the context of the sharing example of FIG. 3, such remediation may result in the revocation of sharing privileges (Access Denied).

In some embodiments, the MCDLP security policy 175 may consider a third contextual parameter related to whether an end-user associated with the activity event 131 is able to confirm or deny the activity event 131 and/or provide situational details surrounding the activity event 131. In certain embodiments, a policy condition 177 in the MCDLP security policy 175 may indicate whether or not an end-user (or multiple end-users) are required to verify the activity event 131. As discussed above, handling of security verification requests and security verification responses may be performed using security verification functions 174 of DLP system 170.

In some examples, the MCDLP security policy 175 may include a policy condition 177 specifying that the end-user 115A who shared the data asset 135 is required to verify the activity event 115 by providing an approval or confirmation response to a verification request. If DLP system determines that the security verification requests sent by DLP system 170 in response to the activity event 131 does not result in a confirmation via a received security verification response, one or more remediation functions 170 may be executed (e.g., to prevent sharing of the data asset 135 and/or to revoke sharing privileges that been given to end-user 115B).

As demonstrated by the example in FIG. 3, in addition to analyzing a data asset 135 for the presence of protected information 137, the DLP system 170 is able to consider a variety of contextual parameters related to an activity event 131 (e.g., share event) to more comprehensively assess whether or not the activity event is authorized. Additionally, because various policy conditions 177 of an MCDLP security policy 175 are able to be customized, an organization can create and deploy MCDLP security policies 175 in a flexible and versatile fashion to accommodate desired security settings for the organization's data assets 135 and protected information 137.

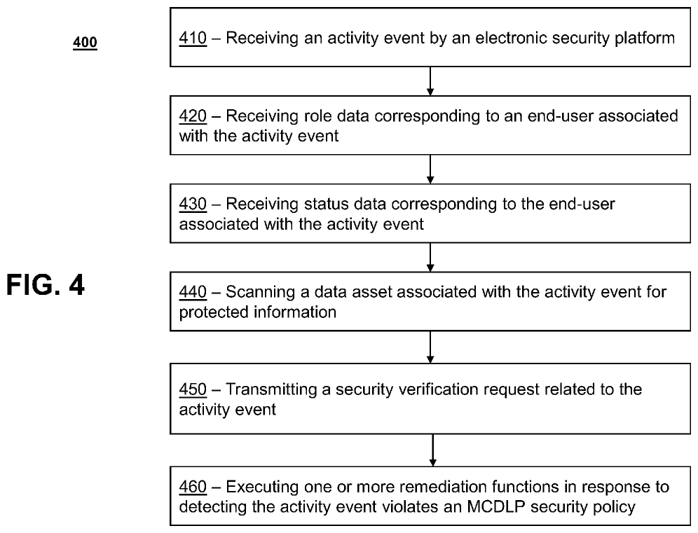

FIG. 4 illustrates a flow chart for an exemplary method 400 for employing MCDLP according to certain embodiments. Method 400 is merely exemplary and is not limited to the embodiments presented herein. Method 400 can be employed in many different embodiments or examples not specifically depicted or described herein. In some embodiments, the steps of method 400 can be performed in the order presented. In other embodiments, the steps of method 400 can be performed in any suitable order. In still other embodiments, one or more of the steps of method 400 can be combined or skipped. In many embodiments, system 100A, system 100B, security enforcement platform 150, and/or DLP system 170 can be configured to perform method 400 and/or one or more of the steps of method 400. In these or other embodiments, one or more of the steps of method 400 can be implemented as one or more computer instructions configured to run at one or more processing devices 102 and configured to be stored at one or more non-transitory computer storage devices 101. Such non-transitory memory storage devices 101 can be part of a computer system associated with system 100A, system 100B, security enforcement platform 150, and/or DLP system 170.

In step 410, an activity event 131 may be received by an electronic security platform 150. In some cases, the activity event 131 may be generated by a SaaS platform 130 and/or enterprise system 195, or user accounts associated with a SaaS platform 130 and/or enterprise system 195. Various types of metadata may be extracted from the activity event 131, including metadata that identifies users associated with the activity event 131 and metadata that identifies an activity type or category associated with the activity event 131. A determination may be made to assess whether the activity event 131 is subject to MCDLP security policy (e.g., an MCDLP security policy 175). As discussed above, such a determination may be made based on the type of activity event, the identity, role, and/or status of one or more users associated with the activity event, the SaaS platform that generated the activity event, the type of asset (e.g., asset 135) associated with the activity event, a timeframe associated with the activity event or any data or metadata associated with activity event.

In step 420, role data for a user associated with an activity event may be requested and/or received (e.g., from an entity system 190 or IMS 191). A determination may be made to assess whether the user's role is compatible with or applicable to an MCDLP security policy concerning the received activity event.

In step 430, status data for a user associated with an activity event may be requested and/or received (e.g., from an entity system 190 or HRIS 192). A determination may be made to assess whether the user's status is compatible with an MCDLP security policy concerning the received activity event.

In step 440, one or more data assets 135 associated with the activity event 131 may be scanned for protected information 137 in order to determine whether the one or more assets 135 associated with the activity event contains protected information 137. In some embodiments, the MCDLP security policy 175 may identify specific types of protected information 137 to be scanned.

In step 450, one or more security verification requests may be transmitted by the electronic security platform 150. As discussed above, security verification requests may be transmitted to various users (e.g., such as the end-user who initiated the activity event 131, security users, supervisors, etc.). In some embodiments, the one or more security verification requests may solicit responses requesting that the end-users verify or confirm the activity event 131.

In step 460, one or more remediation functions 176 may be executed in response to detecting the activity event 131 violates a MCDLP security policy 175. Generally, a remediation action may be performed as soon as any incompatibility between an MCDLP security policy and an activity event is determined. In some examples, a remediation function 176 can be executed if the end-user associated with the activity event 131 does not have a proper status, if the end-user is attempting to share a data asset 135 that is not permitted by his role, and/or if a verification response is not sent in response to the verification request (or is not sent in a timely fashion).

As evidenced by this disclosure, the MCDLP security techniques disclosed herein provide various advantages to users and organizations. One advantage is that the techniques described herein provide increased security by using a multi-context approach (e.g., that considers user role data, user status data, verification requests and responses, sensitive data scanning, etc.) for protecting sensitive information. These benefits are especially realized in connection with utilizing SaaS platforms and managing of sensitive information associated with SaaS accounts. In some cases, the described techniques can be applied to prevent and/or mitigate data breaches and/or unauthorized accessing of sensitive information. Moreover, these techniques can permit organizations to more securely utilize various SaaS platforms and/or enterprise systems in connection with sensitive information without impeding user experiences. Another advantage is that a single, centralized electronic security platform can be used to enforce configurable security policies in connection with sensitive information across varying platforms (e.g., enterprise-based platforms and/or SaaS-based platforms) and/or other software solutions. This centralized platform can increase operational efficiencies and avoid manual review of various accounts and sensitive information. Another advantage is that the security policies can be defined and customized granularly according to each of the platforms (e.g., enterprise-based platforms and/or SaaS-based platforms) and/or other software solutions supported by the centralized platform. Another advantage is that the security verification techniques enable users to easily confirm and/or deny whether activity events occurring on the supported platforms were validly authorized. Many other advantages would be apparent to one of skilled in the art.

In certain embodiments, a computerized method for implementing multi-context data loss prevention is provided. The method includes: storing, by a security enforcement platform, one or more multi-context data loss prevention (MCDLP) security policies for securing protected information included in data assets; receiving, by the security enforcement platform, an activity event corresponding to at least one data asset; determining whether the activity event is authorized by the one or more MCDLP security policies, at least in part, by: (i) analyzing role data corresponding to at least one end-user associated with the activity event; (ii) analyzing status data corresponding to the at least one end-user associated with the activity event; (iii) scanning the at least one data asset to determine if the at least one data asset comprises protected information; and (iv) determining if a verification response was received in connection with the activity event; and executing, by the security enforcement platform, one or more remediation functions in response to determining that the activity event violates the one or more MCDLP security policies.

In certain embodiments, a system for implementing multi-context data loss prevention is provided. The system includes one or more computing devices comprising one or more processing devices and one or more non-transitory storage devices for storing instructions. Execution of the instructions by the one or more processing devices causes the one or more computing devices to perform functions of: storing, by a security enforcement platform, one or more multi-context data loss prevention (MCDLP) security policies for securing protected information included in data assets; receiving, by the security enforcement platform, an activity event corresponding to at least one data asset; determining whether the activity event is authorized by the one or more MCDLP security policies, at least in part, by: (i) analyzing role data corresponding to at least one end-user associated with the activity event; (ii) analyzing status data corresponding to the at least one end-user associated with the activity event; (iii) scanning the at least one data asset to determine if the at least one data asset comprises protected information; and (iv) determining if a verification response was received in connection with the activity event; and executing, by the security enforcement platform, one or more remediation functions in response to determining that the activity event violates the one or more MCDLP security policies.

While various novel features of the invention have been shown, described, and pointed out as applied to particular embodiments thereof, it should be understood that various omissions and substitutions, and changes in the form and details of the systems and methods described and illustrated, may be made by those skilled in the art without departing from the spirit of the invention. Amongst other things, the steps in the methods may be carried out in different orders in many cases where such may be appropriate. Those skilled in the art will recognize, based on the above disclosure and an understanding of the teachings of the invention, that the particular hardware and devices that are part of the system described herein, and the general functionality provided by and incorporated therein, may vary in different embodiments of the invention. Accordingly, the description of system components is for illustrative purposes to facilitate a full and complete understanding and appreciation of the various aspects and functionality of particular embodiments of the invention as realized in system and method embodiments thereof. Those skilled in the art will appreciate that the invention can be practiced in other than the described embodiments, which are presented for purposes of illustration and not limitation. Variations, modifications, and other implementations of what is described herein may occur to those of ordinary skill in the art without departing from the spirit and scope of the present invention and its claims.

What is claimed is:

1. A computerized method for implementing multi-context data loss prevention, the method comprising:
storing, by a security enforcement platform, one or more multi-context data loss prevention (MCDLP) security policies for securing protected information included in data assets;
receiving, by the security enforcement platform, an activity event corresponding to at least one data asset;
determining whether the activity event is authorized by the one or more MCDLP security policies, at least in part, by:
analyzing role data corresponding to at least one end-user associated with the activity event;
analyzing status data corresponding to the at least one end-user associated with the activity event;
scanning the at least one data asset to determine if the at least one data asset comprises protected information; and
determining if a verification response was received in connection with the activity event; and
executing, by the security enforcement platform, one or more remediation functions in response to determining that the activity event violates the one or more MCDLP security policies.

2. The method of claim 1, wherein the security enforcement platform is configured to secure protected information included in data assets stored on one or more software-as-a-service (SaaS) platforms such that:
the security enforcement system remotely monitors activity events originating from a plurality of SaaS accounts over a network, and remotely enforces the one or more MCDLP security policies on the data assets stored across the plurality of SaaS accounts;
the at least one data asset is stored on a SaaS account that is remotely monitored by the security enforcement system;
the activity event originates from the SaaS account and is provided to the security enforcement system over the network; and
in response to determining that the activity event is not compliant with the one or more MCDLP security policies, the security enforcement system transmits one or more commands over the network to the SaaS account in connection with executing the one or more remediation functions.

3. The method of claim 1, wherein the security enforcement platform is configured to secure protected information included data assets stored within an entity system such that:
the security enforcement system monitors activity events originating from one or more entity user accounts within the entity system, and enforces the one or more MCDLP security policies on the data assets stored within the entity system; and
in response to determining that the activity event is not compliant with the one or more MCDLP policies, the security enforcement system transmits one or more commands within the entity system in connection with executing the one or more remediation functions.

4. The method of claim 1, wherein each of the one or more MCDLP security policies include:
a first policy condition identifying an activity event type that is applicable to a corresponding MCDLP security policy, wherein the activity event type corresponds to a share event;
a second policy condition identifying one or more roles that are applicable to the corresponding MCDLP security policy, wherein the one or more roles identified by the second policy condition are compared to the role data corresponding to the at least one end-user;
a third policy condition that identifies one or more unauthorized statuses, wherein the one or more unauthorized statuses are compared to the status data corresponding to the at least one end-user;
a fourth policy condition that identifies one or more protected data types to be scanned according to the corresponding MCDLP security policy, wherein the at least one data asset is scanned to determine if the at least one data asset comprises the protected information corresponding to the one or more protected data types; and
a fifth policy condition that includes verification criteria for confirming or denying the activity event according to the corresponding MCDLP security policy, wherein the verification criteria identifies one or more end-users to receive verification requests and identifies a time period for receiving the verification response from the one or more end-users; and
wherein the security enforcement platform determines whether the activity event is authorized by the corresponding MCDLP security policy based, at least in part, on the first policy condition, the second policy condition, the third policy condition, the fourth policy condition, and the fifth policy condition.

5. The method of claim 4, wherein the method further comprises:
evaluating the first policy condition and the second policy condition to determine whether the activity event is applicable to the corresponding MCDLP security policy; and
in response to determining that the activity event is applicable to the corresponding MCDLP security policy, evaluating the third policy condition, the fourth policy condition, and the fifth policy condition to determine if the activity event is authorized or unauthorized under the corresponding MCDLP security policy.

6. The method of claim 1, wherein determining whether the activity event is compliant with the one or more MCDLP security policies further includes:
comparing the status data corresponding to the at least one end-user with at least one policy condition set forth in the one or more MCDLP security policies, and determining that the activity event is not compliant with the one or more MCDLP security policies if the status data does not satisfy the at least one policy condition; and
determining that the activity event is not compliant with the one or more MCDLP security policies in response to the verification response not being received within a predetermined time period or in response to the verification response include a denial message.

7. The method of claim 1, wherein determining whether the activity event is compliant with the one or more MCDLP security policies includes:
determining, by the security evaluation platform, whether the one or more MCDLP security policies apply to the activity event based, at least in part, on a comparison of the role data corresponding to the to at least one end-user with at least one policy condition set forth in the one or more MCDLP policies;
in response to determining that the one or more MCDLP security policies apply to the activity event, determining, by the security evaluation platform, that the activity event is not compliant with the one or more MCDLP security policies in response to: a) detecting that the at least one data asset comprises the protected information based on said scanning; and b) detecting at least one of following conditions: i) the status data corresponding to the at least one end-user associated with the activity event corresponds to an unauthorized status specified by a policy condition set forth in the one or more MCDLP security policies; ii) the verification response is not received within a predetermined time period specified by a policy condition set forth in the one or more MCDLP security policies; or iii) the verification response is received and denies the activity event.

8. The method of claim 1, wherein the security enforcement platform communicates with an identify management system (IMS) to obtain the role data corresponding to at least one end-user and the security enforcement platform communicates with a human resource information system (HRIS) to obtain the status data corresponding to at least one end-user.

9. The method of claim 1, wherein the activity event corresponding to at least one data asset is generated in response to a first end-user sharing, or attempting to share, the at least one data asset with a second end-user, and executing the one or more remediation functions includes at least one of: revoking sharing privileges or access privileges granted to the second end-user; preventing the at least one data asset from being shared with the second end-user; encrypting the at least one data asset; or quarantining the at least one data asset.

10. The method of claim 1, wherein the security enforcement platform operates as a centralized controller that remotely communicates with one or more SaaS platforms to enforce the one or more MCDLP security policies on data assets stored by the one or more SaaS platforms.

11. A system of one or more computing devices comprising one or more processing devices and one or more non-transitory storage devices for storing instructions, wherein execution of the instructions by the one or more processing devices causes the one or more computing devices to:
store, by a security enforcement platform, one or more multi-context data loss prevention (MCDLP) policies for securing protected information included in data assets;
receive, by the security enforcement platform, an activity event corresponding to at least one data asset;
determine whether the activity event is authorized by the one or more MCDLP policies, at least in part, by:
analyzing role data corresponding to at least one end-user associated with the activity event;
analyzing status data corresponding to the at least one end-user associated with the activity event;
scanning the at least one data asset to determine if the at least one data asset comprises protected information; and
determining if a verification response was received in connection with the activity event; and
execute, by the security enforcement platform, one or more remediation functions in response to determining that the activity event violates the one or more MCDLP policies.

12. The system of claim 11, wherein the security enforcement platform is configured to secure protected information included in data assets stored on one or more software-as-a-service (SaaS) platforms such that:
the security enforcement system remotely monitors activity events originating from a plurality of SaaS accounts over a network, and remotely enforces the one or more MCDLP security policies on the data assets stored across the plurality of SaaS accounts;
the at least one data asset is stored on a SaaS account that is remotely monitored by the security enforcement system;
the activity event originates from the SaaS account and is provided to the security enforcement system over the network; and
in response to determining that the activity event is not compliant with the one or more MCDLP security policies, the security enforcement system transmits one or more commands over the network to the SaaS account in connection with executing the one or more remediation functions.

13. The system of claim 11, wherein the security enforcement platform is configured to secure protected information included data assets stored within an entity system such that:
the security enforcement system monitors activity events originating from one or more entity user accounts within the entity system, and enforces the one or more MCDLP security policies on the data assets stored within the entity system; and
in response to determining that the activity event is not compliant with the one or more MCDLP policies, the security enforcement system transmits one or more commands within the entity system in connection with executing the one or more remediation functions.

14. The system of claim 11, wherein each of the one or more MCDLP security policies include:
a first policy condition identifying an activity event type that is applicable to a corresponding MCDLP security policy, wherein the activity event type corresponds to a share event;
a second policy condition identifying one or more roles that are applicable to the corresponding MCDLP security policy, wherein the one or more roles identified by the second policy condition are compared to the role data corresponding to the at least one end-user;
a third policy condition that identifies one or more unauthorized statuses, wherein the one or more unauthorized statuses are compared to the status data corresponding to the at least one end-user;
a fourth policy condition that identifies one or more protected data types to be scanned according to the corresponding MCDLP security policy, wherein the at least one data asset is scanned to determine if the at least one data asset comprises the protected information corresponding to the one or more protected data types; and
a fifth policy condition that includes verification criteria for confirming or denying the activity event according to the corresponding MCDLP security policy, wherein the verification criteria identifies one or more end-users to receive verification requests and identifies a time period for receiving the verification response from the one or more end-users; and
wherein the security enforcement platform determines whether the activity event is authorized by the corresponding MCDLP security policy based, at least in part, on the first policy condition, the second policy condition, the third policy condition, the fourth policy condition, and the fifth policy condition.

15. The system of claim 14, wherein:
the first policy condition and the second policy condition are evaluated to determine whether the activity event is applicable to the corresponding MCDLP security policy; and
in response to determining that the activity event is applicable to the corresponding MCDLP security policy, the third policy condition, the fourth policy condition, and the fifth policy condition are evaluated to determine if the activity event is authorized or unauthorized under the corresponding MCDLP security policy.

16. The system of claim 11, wherein determining whether the activity event is compliant with the one or more MCDLP security policies further includes:
comparing the status data corresponding to the at least one end-user with at least one policy condition set forth in the one or more MCDLP security policies, and determining that the activity event is not compliant with the one or more MCDLP security policies if the status data does not satisfy the at least one policy condition; and
determining that the activity event is not compliant with the one or more MCDLP security policies in response to the verification response not being received within a predetermined time period or in response to the verification response include a denial message.

17. The system of claim 11, wherein determining whether the activity event is compliant with the one or more MCDLP security policies includes:
determining, by the security evaluation platform, whether the one or more MCDLP security policies apply to the activity event based, at least in part, on a comparison of the role data corresponding to the to at least one end-user with at least one policy condition set forth in the one or more MCDLP policies;
in response to determining that the one or more MCDLP security policies apply to the activity event, determining, by the security evaluation platform, that the activity event is not compliant with the one or more MCDLP security policies in response to: a) detecting that the at least one data asset comprises the protected information based on said scanning; and b) detecting at least one of following conditions: i) the status data corresponding to the at least one end-user associated with the activity event corresponds to an unauthorized status specified by a policy condition set forth in the one or more MCDLP security policies; ii) the verification response is not received within a predetermined time period specified by a policy condition set forth in the one or more MCDLP security policies; or iii) the verification response is received and denies the activity event.

18. The system of claim 11, wherein the security enforcement platform communicates with an identify management system (IMS) to obtain the role data corresponding to at least one end-user and the security enforcement platform communicates with a human resource information system (HRIS) to obtain the status data corresponding to at least one end-user.

19. The system of claim 11, wherein the activity event corresponding to at least one data asset is generated in response to a first end-user sharing, or attempting to share, the at least one data asset with a second end-user, and executing the one or more remediation functions includes at least one of: revoking sharing privileges or access privileges granted to the second end-user; preventing the at least one data asset from being shared with the second end-user; encrypting the at least one data asset; or quarantining the at least one data asset.

20. The system of claim 11, wherein the security enforcement platform operates as a centralized controller that remotely communicates with one or more SaaS platforms to enforce the one or more MCDLP security policies on data assets stored by the one or more SaaS platforms.
